(19) United States
(12) Patent Application Publication
(10) Pub. No.: US 2013/0085703 A1
(43) Pub. Date: Apr. 4, 2013

(54) Histogram-Based Linearization of Analog-to-Digital Converters

(71) Applicants: Ray (Ramon) GOMEZ, San Juan Cap, CA (US); Bruce J. Currivan, Dove Canyon, CA (US); Lin He, Irvine, CA (US); Loke Tan, Newport Coast, CA (US); Frank Van der Goes, Den Haag (NL); Cy (Chun-Ying) Chen, Irvine, CA (US); Jiangfeng Wu, Irvine, CA (US); Thomas Kolze, Phoenix, AZ (US)

(72) Inventors: Ray (Ramon) GOMEZ, San Juan Cap, CA (US); Bruce J. Currivan, Dove Canyon, CA (US); Lin He, Irvine, CA (US); Loke Tan, Newport Coast, CA (US); Frank Van der Goes, Den Haag (NL); Cy (Chun-Ying) Chen, Irvine, CA (US); Jiangfeng Wu, Irvine, CA (US); Thomas Kolze, Phoenix, AZ (US)

(73) Assignee: Broadcom Corporation, Irvine, CA (US)

(21) Appl. No.: 13/249,845

(22) Filed: Sep. 30, 2011

(51) Int. Cl. G06F 17/17; G06F 19/00

(52) U.S. Cl. 702/109

(57) ABSTRACT

Embodiments provide histogram-based methods and system to estimate the transfer function of an ADC, and subsequently to linearize a non-linear ADC transfer function. Embodiments include blind algorithms that require no a priori knowledge of the input signal distribution. Embodiments can be implemented using cumulative (i.e., cumulative distribution function (CDF)) or non-cumulative (i.e., probability density function (PDF)) histograms. According to embodiments, a non-linear transfer function can be estimated by linearly approximating successive local intervals of the transfer function. Linearly approximated successive local intervals of the transfer function can then be used to fully characterize and closely estimate the transfer function.

### BACKGROUND

1. Field of the Invention

The present invention relates generally to analog-to-digital converter (ADC) linearization.

2. Background Art

An analog-to-digital converter (ADC) converts a received analog input into a digital code output according to a transfer function. An ideal ADC has quantization intervals, including a maximum and a minimum digital code output, but otherwise a linear transfer function. In practice, however, ADCs suffer from transfer function non-linearity, which limits the dynamic range of the ADC. Accordingly, there is a need for techniques to linearize ADC transfer functions. The same need also exists for other analog signal processing elements, including amplifiers and mixers, for example.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the effects on an analog-to-digital converter (ADC) output of a non-linear ADC transfer function and a non-linear ADC input.

FIG. 2 illustrates an example non-linear transfer function of an ADC.

FIG. 3 illustrates an example system for estimating the transfer function of an ADC according to an embodiment of the present invention.

FIG. 4 illustrates an example system for generating ADC output histograms according to an embodiment of the present invention.

FIG. 5 is a process flowchart of a method of estimating a transfer function of an ADC according to an embodiment of the present invention.

FIG. 6 illustrates an example system for providing a linearized ADC according to an embodiment of the present invention.

The present invention will be described with reference to the accompanying drawings. Generally, the drawing in which an element first appears is typically indicated by the leftmost digit(s) in the corresponding reference number.

### DETAILED DESCRIPTION OF EMBODIMENTS

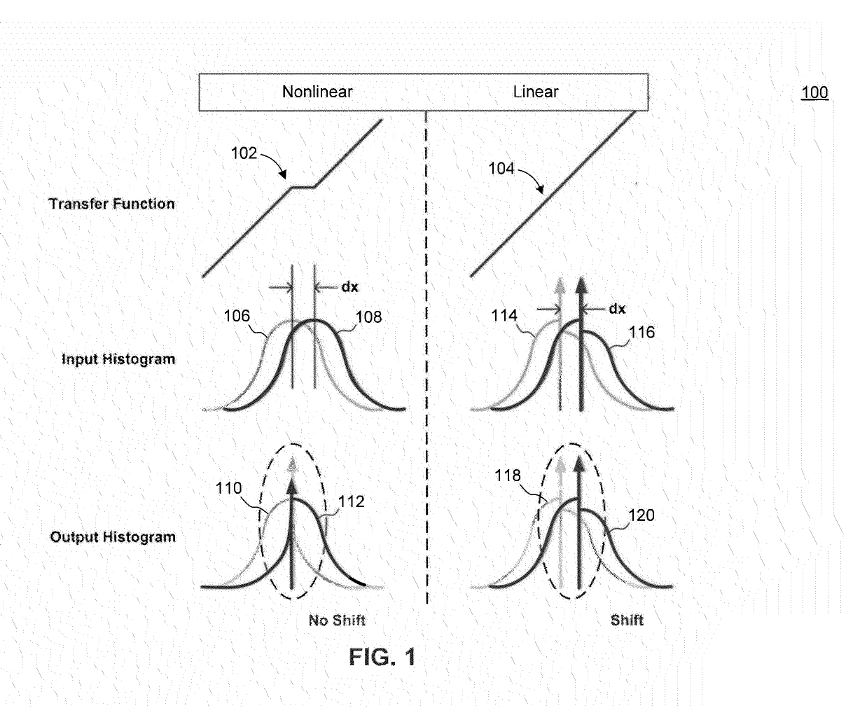

FIG. 1 illustrates the effects on an analog-to-digital converter (ADC) output of a non-linear ADC transfer function and a non-uniformly distributed ADC input. The transfer function illustrated may also be of an amplifier, mixer, or other analog signal processing element, for example.

FIG. 1 shows a non-linear transfer function 102 of a first ADC. A first input signal having a normal input histogram 106 (or probability density function (PDF)) is applied to the first ADC. The resulting output produces an output histogram 110. As shown in FIG. 1, output histogram 110 exhibits a spike (i.e., large count value) for a particular ADC code value, due to the non-linearity in transfer function 102. Specifically, the spike in output histogram 110 is caused by a range of input values of the first input signal all being mapped to the same ADC code value by transfer function 102.

Subsequently, the first input signal is shifted by an offset “dx” and applied to the first ADC. An input histogram 108 of the shifted first input signal has identical distribution as input histogram 106, but is shifted relative to input histogram 106 by the offset “dx.” The resulting output due to the shifted first input signal produces an output histogram 112. Like output histogram 110, output histogram 112 exhibits a spike due to the non-linearity in transfer function 102. Furthermore, the spike occurs for the same ADC code value as in output histogram 110, i.e., no shift occurs in the spike location. However, as shown in FIG. 1, output histograms 110 and 112 have different overall distributions

FIG. 1 also shows a linear transfer function 104 of a second ADC. A second input signal having a non-normal (skewed) input histogram 114 is applied to the second ADC. The resulting output produces an output histogram 118. As shown in FIG. 1, output histogram 118 exhibits a spike for a particular ADC code value, due to the skew in the PDF of the second input signal. Specifically, the spike in output histogram 118 is caused by the second input signal taking the same value a disproportionate amount of time relative to other values.

Subsequently, the second input signal is shifted by an offset “dx” and applied to the second ADC. An input histogram 116 of the shifted second input signal has identical distribution as input histogram 114 (i.e., same skew), but is shifted relative to input histogram 114 by the offset “dx.” The resulting output due to the shifted second input signal produces an output histogram 120. As shown in FIG. 1, output histogram 120 has identical distribution as output histogram 118, and is only shifted by an offset (ADC code offset that corresponds to the input offset “dx”) relative to output histogram 118.

Accordingly, depending on the observed output histogram behavior resulting from shifting the input signal by an offset, the ADC transfer function can be determined as linear or non-linear. Other approaches can also be used to “sound” the nonlinearity of the ADC transfer function. For example, rather than shifting the input signal by an offset, the input signal can be scaled by a gain factor so that x(t) and a*x(t) are applied to the ADC. The observed output histogram will be perturbed in a way that will permit characterization of the ADC transfer function.

Embodiments of the present invention, as further described below, exploit the above described observations regarding the produced output histograms in order to characterize an ADC transfer function. Specifically, embodiments provide histogram-based algorithms to estimate the transfer function of an ADC, and subsequently to linearize a non-linear ADC transfer function. Embodiments can also be used to linearize other analog signal processing elements, in addition to ADCs, including amplifiers and mixers, for example. For the purpose of illustration only, linearization techniques are described herein with application to ADCs. As would be understood by a person of skill in the art based on the teachings herein, the same techniques can be equally applied to other analog elements. The techniques may be applied to individual elements or a chain of concatenated elements.

In embodiments, the algorithms are blind algorithms that require no a priori knowledge of the input signal distribution. Embodiments can be implemented using cumulative (i.e., cumulative distribution function (CDF)) or non-cumulative (i.e., probability density function (PDF)) histograms. In the following, embodiments that use cumulative histograms will be described. As would be understood by a person of skill in the art based on the teachings herein, the same embodiments can be implemented using non-cumulative histograms. The adaptation of such embodiments to non-cumulative histograms will be apparent to a person of skill in the art based on the teachings herein, as there is a one-to-one relationship between cumulative histograms and non-cumulative histograms. For example, a non-cumulative histogram can be obtained by differencing consecutive “bins” of a corresponding cumulative histogram (differencing consecutive bins of a cumulative histogram results in a bin value of the corresponding non-cumulative histogram).

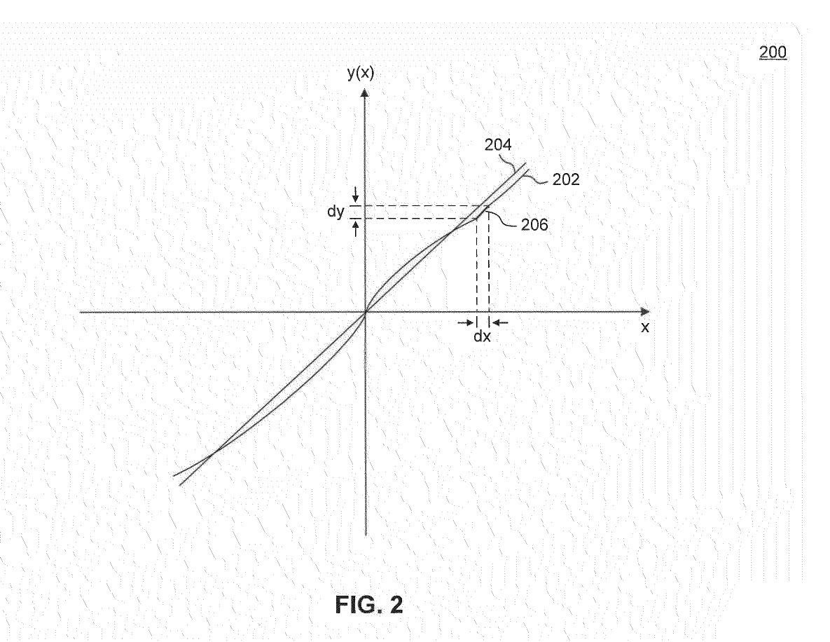

FIG. 2 illustrates an example non-linear transfer function 202 of an ADC. Transfer function 202 provides the digital code output of the ADC (denoted as “y(x)”) as a function of the ADC analog input signal (denoted with the variable “x”). As shown in FIG. 2, example transfer function 202 is non-linear in the sense that it deviates in certain regions from a straight line 204 having the equation y(x)=x. As illustrated, the mapping of the ADC input signal to the ADC digital code output by transfer function 202 may not be one-to-one mapping over certain regions of transfer function 202. Further, in different regions of transfer function 202, input signal ranges of the same widths (i.e., including the same number of input values) may map to digital code ranges of different widths (i.e., including different number of digital codes). For example, considering a region 206 of transfer function 202, as shown in FIG. 2, a range “dx” of the input signal maps to a narrower range “dy” of the ADC digital code output. In addition, region 206 itself may be non-linear, i.e., not a straight line.

According to embodiments, a non-linear transfer function, y=g(x), such as transfer function 202, for example, can be estimated by linearly approximating successive local intervals of the transfer function, each local interval being sufficiently narrow that it can be approximated itself by a straight line. For example, assuming that region 206 of transfer function 202 is sufficiently narrow, the transfer function 202 over the local interval provided by region 206 can be approximated by a secant line that connects the two ends of the local interval. Linearly approximated successive local intervals of transfer function 202 can then be used to fully characterize and closely estimate transfer function 202.

In addition to linearizing the transfer function itself, embodiments compensate for other non-linearities and/or non-idealities as described herein. An ADC transfer function can be described as outputting N digital code outputs, yₙ, n=1, N, based on explicit thresholds THₙ, n=1,2, . . . , N−1, which define the quantization of the analog input signal x(t) into the N digital code outputs. For example, for the analog input x(t) falling between the thresholds TH₁ and TH₂ (TH₁<x<TH₂), the resulting ADC digital output code is y₂. Implicit thresholds TH₀ and TH_{N} may be considered −inf and +inf, respectively. Typically, the analog input signal x(t) may undergo non-linear distortion prior to reaching the ADC, or within the ADC prior to the quantization just described. In addition, the thresholds THₙ of the ADC may be non-ideal. For example, often it is desired to employ uniformly spaced thresholds, and assign consecutive (constantly incrementing) numerical values (for mathematical processing purposes) to the ADC digital code outputs yₙ. As such, non-uniformly spaced thresholds introduce unwanted effects, including nonlinear distortion. Embodiments compensate for these non-idealities and also compensate for analog non-idealities preceding the quantization, such as due to amplifier compression and/or other nonlinear processing, for example. Embodiments also allow arbitrary assignment (i.e., non-consecutive) of the digital code numerical values (for mathematical purposes) and do not require uniform quantization levels.

As noted above, embodiments rely on histogram-based techniques to perform this linear local approximation of non-linear transfer functions. Embodiments do not require a priori knowledge of the input signal distribution, but only require that the input signal applied to the ADC fully exercises the input dynamic range of the ADC (in order to linearize the entire dynamic range of the ADC). It is noted that if a particular input signal to the ADC does not fully exercise the input dynamic range of the ADC, then the unexercised ranges of the ADC input will not be “linearized.” However, this does not represent a drawback of embodiments, since the input signal does not exercise these ranges and linearization of these ranges is not needed for that particular input signal.

Furthermore, embodiments do not require any special training inputs and use the actual (data) input to the ADC to linearize the ADC. As such, embodiments linearize the ADC while the ADC is online (“in service”), and can thus compensate for time-varying non-linearities and/or non-idealities. Further, the linearization of an ADC can take place over a single continuous time period or multiple discrete time periods. For example, embodiments can linearize the entire dynamic range of the ADC in a single continuous time period if the ADC is fully exercised by an input signal during the single continuous time period. Alternatively, embodiments can linearize different sub-ranges (which may or may not be consecutive) of the ADC at different time periods, as the input signal applied to the ADC allows these sub-ranges to be exercised.

In the following, example embodiments will be presented. In the description of the embodiments, the terms “first derivative,” “first local derivative,” “second derivative,” “second local derivative,” “third derivative”, and “third local derivative” are used. It is important to note that the terms “first,” “second,” and “third” are only used as identifiers in order to distinguish the different derivatives from each other, and not to associate a mathematical meaning with the derivatives. Each of the “first derivative,” “first local derivative,” “second derivative,” “second local derivative,” “third derivative,” and “third local derivative” represents a first derivative in the mathematical sense. For example, the term “second derivative” or “second local derivative” does not represent a derivative of a derivative but is a first derivative in the mathematical sense.

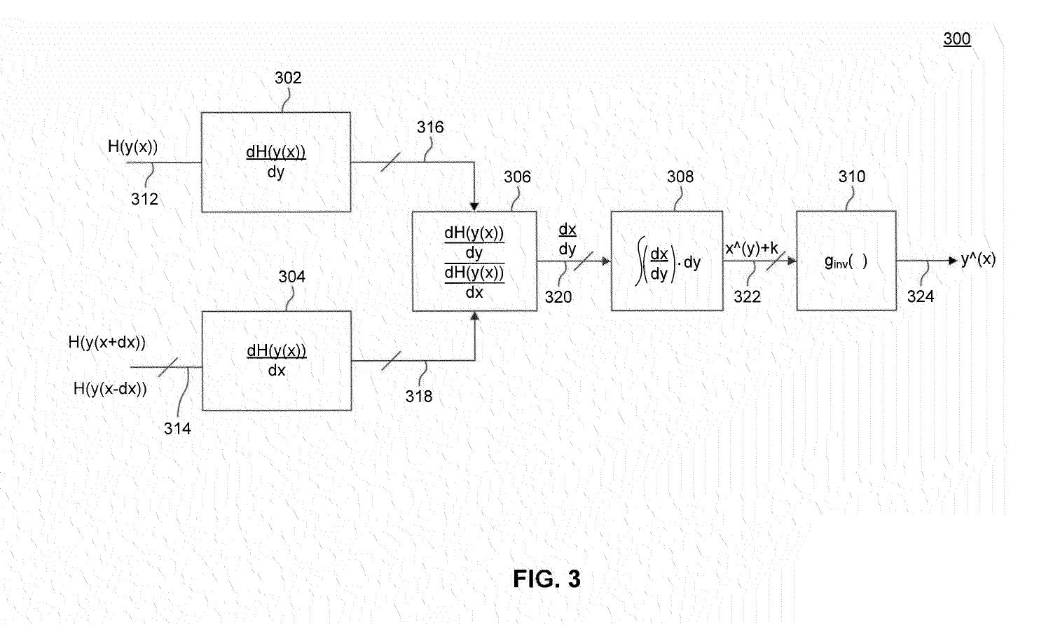

FIG. 3 illustrates an example system 300 for estimating the transfer function of an ADC according to an embodiment of the present invention. As shown in FIG. 3, example system 300 includes a first differentiator module 302, a second differentiator module 304, a divider module 306, an integrator module 308, and optionally an inverter module 310. Example system 300 may be implemented using hardware, software, or a combination thereof.

Differentiator module 302 receives an input signal 312 that includes a measured output histogram H(y(x)) of the ADC. The output histogram H(y(x)) is generated using an input signal “x” that spans the entire dynamic range of the ADC. The output histogram H(y(x)) consists of values Hₙ, n=1,2, . . . N, each corresponding to a respective digital code output of the N digital code outputs of the ADC.

Differentiator module 302 computes a first derivative dH(y(x))/dy that represents a derivative of the output histogram H(y(x)) with respect to the digital code “y.” In an embodiment, differentiator module 302 computes the first derivative for every code bin of the output histogram H(y(x)) to produce a plurality of first local derivatives of the output histogram H(y(x) with respect to the digital code. In an embodiment, the first local derivative for a code bin “y” is approximated numerically as [H(y+dy)−H(y−dy)]/2dy, where “dy” is a bin offset. In other words, the first local derivative for the code bin is determined by subtracting the counts of two adjacent code bins of the output histogram H(y(x)), one bin offset by “+dy” and the other bin offset by “−dy,” and dividing the result by “2dy.” The count of a code bin represents in a non-cumulative histogram the number of times that a value of the input signal is mapped to the digital code output, represented by the code bin. In a cumulative histogram, the count represents the number of times that a value of the input signal is mapped to a digital code output below and up to (and including) the digital code output, represented by the code bin. For the maximum and minimum bins the derivative is calculated with [H(y)−H(y−dy)]/dy and [H(y+dy)−H(y)]/dy, respectively, in one embodiment.

In another embodiment, the derivative dH(y(x))/dy is approximated numerically at a value yₙ by differencing Hₙ−Hₙ₋₁, and dividing the difference by y_{delta}_{_{—}}ₙ=(yₙ₊₁−yₙ₋₁)/2, for n=2,3, . . . N−1. The derivative dH(y(x))dy is approximated as [Hₙ−Hₙ₋₁]/y_{delta}_{_{—}}ₙ which is an approximation of the probability density function of y, p_{y}(yₙ). With uniformly numerically stepped digital output codes, the denominator is yₙ−yₙ₋₁ in this embodiment, the same value for each “n”. To determine the first derivative at the maximum and minimum valued digital output codes, y_{N} and y₁, the denominator can use the value computed for the neighboring digital output codes, or some other extrapolation, or the linearization can continue without requiring the first derivative at the maximum and minimum digital output codes. If the first derivative at the minimum digital output code is used, it is computed with H₀ defined as equal to zero for this computation. Therefore, in an embodiment, p_{y}(yₙ) is computed for n=1, 2, . . . , N.

The previous examples for calculating dH(y)/dy represent first order approximation (a difference of a single pair of values) of the derivative at a given code or output signal value, y. In other embodiments, the derivative at some or all code or output values y may use higher order techniques, involving in general more than a pair of histogram values. Curve fitting (such as to a polynomial of a given maximum order, and/or including and/or excluding certain teems such as even or odd powers in the polynomial expansion, and/or such as finding parameters to best-fit suitable parametric models) and smoothing techniques may be applied to the estimation (calculation) of the derivative dH(y)/dy across the set of digital codes in other embodiments.

Differentiator module 302 generates an output signal 316 that includes the computed first local derivatives of the output histogram H(y(x)) with respect to the digital code (or the output signal), for the full set of digital code outputs (or output signal values) (or a representative sampling or characterization with respect to the output signal values). Differentiator module 302 provides output signal 316 to divider module 306.

Differentiator module 304 receives an input signal 314 that includes first and second output histograms H(y(x+dx)) and H(y(x−dx)), measured by applying a first input signal “x−dx” and a second input signal “x+dx,” respectively, to the ADC. In another embodiment, differentiator module 304 receives an input signal 314 that includes the first output histogram H(y(x)) (that was included in input signal 312), and a second output histogram H(y(x−dx)). Alternatively, input signal 314 includes the output histograms H(y(x+dx)), generated by applying the input signal “x−dx,” and H(y(x)) (same as included in signal 312).

Each of the first and second input signals spans the entire dynamic range of the ADC, or at least the range over which calibration is to be accomplished. The first and second input signals are generated by adding DC offsets to the input signal “x,” the DC offsets being equal to “−dx” and “+dx,” respectively. In embodiments, the DC offsets are known calibration signals, which are small and out-of-band (DC), and thus unobtrusive. In other embodiments, the offset is time-varying (and may be out-of-band compared to the signals of interest, but not restricted to DC). For example, without limitation, the offset may be a sinusoid of amplitude “dx.”, As such, the produced histograms are synchronized with the time-varying offset so as to still provide (as an example) a histogram corresponding to a “−dx” offset and a histogram corresponding to a “+dx” offset. As long as normalization of histograms is provided, it is not necessary that the various histograms be collected or created using the same number of samples.

Differentiator module 304 computes a second derivative dH(y(x))/dx that represents a derivative of the output histogram H(y(x)) with respect to the input “x.” In an embodiment, differentiator module 304 computes the second derivative for every code bin of the output histogram H(y(x)) to produce a plurality of second local derivatives of the output histogram H(y(x)) with respect to the input. In another embodiment, the differentiator module 304 computes the second derivative for every code bin except for the bins corresponding to the maximum and minimum valued digital codes. In an embodiment, the second local derivative for an input value “x” is calculated as [H(y(x+dx)−H(y(x−dx)]/2dx, where “dx” is the absolute value of the DC offsets added to the input signal to generate the first and second output histograms. In other words, the plurality of second local derivatives are generated by subtracting, bin by bin, the first and second output histograms H(y(x+dx)) and H(y(x−dx)), and dividing the result by “2dx.”

In another embodiment, assuming that Hₙ=Probability{x<THₙ}, by applying an input x^{˜}=x+dx, a second histogram is collected wherein Hₙ^{˜}=Probability{x+dx<THₙ=Probability{THₙ−dx<THₙ}. Note that [Hₙ=Hₙ^{˜}=Probability{THₙ−dx<x<THₙ}. Thus, the ratio [Hₙ−Hₙ^{˜}]/dx approximates the probability density function of the input x(t) at the value THₙ, which can be written as pₓ(THₙ). In an embodiment, module 304 computes this ratio for every THₙ, n=1, . . . , N. In another embodiment, module 304 computes the ratio for every THₙ, n=2, . . . , N−1.

In another embodiment, the second local derivatives dH(y(x))/dx are approximated at (roughly) the midpoints of each of the intervals [THₙ₋₁, THₙ} by averaging the approximate probability density functions at the two ends of each interval. For example, dH(y(x))/dx for y=yₙ is set to [pₓ(THₙ₌₁)+pₓ(THₙ)]/2. In other embodiments the calculation of the derivative dH(y(x))/dx uses curve fitting and/or smoothing of the values of pₓ(THₙ) for each n, such as fitting to polynomials and/or to parametric models, to approximate the probability density function pₓ(*) at the midpoints of the input ranges mapped to each digital code. Similarly, the probability density function approximation can be extrapolated so that the second local derivative is estimated at the maximum and minimum digital code values as well. In another embodiment, the approximation of the second local derivative at the maximum and minimum digital code values can be computed as pₓ(TH_{N})/2 and pₓ(TH₁)/2, respectively.

Differentiator module 304 generates an output signal 318 that includes the computed second local derivatives of the output histogram H(y(x)) with respect to the input. Differentiator module 304 provides output signal 318 to divider module 306.

Divider module 306 receives signals 316 and 318 from differentiator modules 302 and 304, respectively. Differential module 306 computes a third derivative dx/dy that represents a derivative of the input with respect to the digital code. In an embodiment, divider module 306 computes the third derivative for every code bin of the output histogram H(y(x)) to produce a plurality of third local derivatives of the input with respect to the digital code. In an embodiment, the plurality of third local derivatives are generated by dividing, bin by bin, corresponding values of the first local derivatives and the second local derivatives (i.e., that correspond to the same code bin value). The third local derivatives represent local slopes of the inverse function, x=gᵢₙᵥ(y), of the transfer function g(x) of the ADC (and any analog processing elements preceding the ADC, in general). The inverse function of the transfer function provides the ADC input “x” as a function of the digital code output “y” of the ADC. Divider module 306 generates an output signal 320 that includes the computed third local derivatives, and provides output signal 320 to integrator module 308.

As noted above, dH(y)/dy corresponds to an approximation of the probability density function of y, p_{y}, at the y values where it is computed, and dH(y(x))/dx corresponds to an approximation of the probability density function of x, pₓ, at the values of y where it is computed. Thus, dx/dy=dx/dg=dgᵢₙᵥ/dy=p_{y}/pₓ. Thus, by approximating the relevant distribution functions across the range of values of the ADC output y, as shown above, information characterizing the transfer function g( ) and its desired inverse, gᵢₙᵥ( ), sufficient for practical implementation of gᵢₙᵥ(y) (as will be shown below), can be obtained. In another embodiment, the third local derivatives are generated by dividing the values of curve fit and/or smoothed expressions for the first and second derivatives. In another embodiment, the numerator in the ratio computed in 306 is dH(y(x))/dx and the denominator is dH(y)/dy, yielding dy/dx, and the reciprocal (dx/dy) is generated and processed subsequently.

Integrator module 308 integrates each of the third local derivatives provided by signal 320, with respect to the digital code, to generate an estimate or approximation of gᵢₙᵥ(y) (which is denoted here by x̂(y)), the inverse of the ADC transfer function. In one embodiment, module 308 generates a plurality of respective estimate functions x̂(y) that approximate the inverse function of the transfer function of the ADC (i.e., x(y)=gᵢₙᵥ(y(x))), where each of the estimate functions linearly approximates the inverse function of the transfer function over a respective local interval of the ADC digital code output (or a corresponding local interval of the input). In the embodiment of FIG. 3, integrator module 308 generates an output signal 322 that includes the generated estimate functions, and provides output signal 322 to inverter module 310.

In an embodiment, inverter module 310 receives signal 322 from integrator module 308, and inverts each of the estimate functions provided by signal 322 to generate respective estimate functions 324, ŷ(x), that approximate the transfer function of the ADC. In this embodiment, each of the estimate functions ŷ(x) linearly approximates the transfer function of the ADC over a respective local interval of the ADC input (or a corresponding interval of the ADC digital code output).

Together, the estimate functions ŷ(x) provide a linear local approximation of the non-linear transfer function of the ADC. The estimate functions ŷ(x) can be used to linearize the ADC. For example, in an embodiment, the estimate functions ŷ(x) are used in a look up table (or alternatively, the estimate functions x̂(y) can be used) that receives the ADC output and maps the ADC output to a linearized ADC output.

In another embodiment, module 308 performs the integration of a plurality of dx/dy values (e.g., calculated at y=yₙ, n=2,3, . . . N−1, or e.g., calculated at y=yₙ, n=1,2,3, . . . N) provided by signal 320. Note that dx/dy=dgᵢₙᵥ/dy=p_{y}(y)/pₓ(x(y))|_{y}. As such, in an embodiment, the ratio p_{y}(y)/pₓ(x(y))|_{y} is evaluated at a plurality of y values, e.g., y=yₙ, n=2,3, . . . , N−1, or, e.g., y=yₙ, n=1,2,3, . . . , N. In another embodiment the ratio dx/dy is provided by {[Hₙ−Hₙ₋₁]/y_{delta}_{_{—}}ₙ}/{([Hₙ₋₁−Hₙ₋₁^{˜}])/(2dx)}, with n=2,3, . . . , N−1, as described above. In another embodiment, the ratio dx/dy includes the terms n=1 and n=N by evaluating the ratio at the maximum and minimum extremes as described above. In a further embodiment, module 308 performs the integration of ((dx/dy).dy) by evaluating a plurality of values, Sₘ, given by SUM_{n=2 to m} {[Hₙ−Hₙ₋₁]/y_{delta}_{_{—}}ₙ}/{(Hₙ₋₁−Hₙ₋₁^{˜}]+[Hₙ−Hₙ^{˜}])/(2dx)}*y_{delta}_{_{—}}ₙ} for m=2, 3, . . . N−1. In another embodiment, the sums include the terms m=1 and m=N. Each of the plurality of terms Sₘ corresponds to the integration of (dgᵢₙᵥ/dy)*dy up to y=yₘ.

The result of integrating (dgᵢₙᵥ/dy)*dy over y yields gᵢₙᵥ plus an arbitrary constant offset, which is represented in FIG. 3 by “k.” The integration result may be described as Sₘ=gᵢₙᵥ(yₘ)+k. Since k is arbitrary, in some embodiments, an appropriate value of “k” is determined to adjust the Sₘ values (e.g., subtract from the Sₘ values to arrive at gᵢₙᵥ(yₘ)). In an embodiment, the value of “k” is set to remove DC offset from the ADC. For example, if the input is assumed to have a zero mean, then the offset may be determined so that the adjusted (“linearized”) ADC has a zero mean as follows according to an embodiment: Let the relative occurrences of digital code output values yₘ be Prₘ, set gᵢₙᵥ(yₘ) such that gᵢₙᵥ(yₘ)=Sₘ−k, where k=SUM{Sₘ*Prₘ}/SUM{Prₘ}, where the sums are over m=2,3, . . . N−1. In another embodiment, the sums include the terms m=1 and m=N.

Since the units of the output of the inverse function x=gᵢₙᵥ(y) are units of the input to the ADC (i.e., analog input), and in some embodiments it is desired to “linearize” or “undo” the nonlinear transfer function of the ADC but maintain the units of the ADC output (i.e., digital code), an additional gain term may be incorporated into the synthesized inverse function for linearizing the ADC output. In other embodiments, a gain term may also be incorporated to provide improved inversion of the ADC transfer function. As described above, gᵢₙᵥ(yₘ) and the Sₘ values are generated from approximations of the first and second derivatives. As such, the estimate of the inverse transfer function can be improved by the addition of the gain term.

With the arbitrary offset “k” and desire for maintaining the units at the ADC output, in some embodiments, a plurality of ordered pairs {yₘ, a*Sₘ+b} are synthesized, where “a” and “b” are constants determined such that a*Sₘ+b equals (in the Least Squares sense) yₘ. This entails solving for “a” and “b” in the Least Squares sense, then using the generated “a” and “b” together with the plurality of Sₘ values, to generate y*ₘ=a*Sₘ+b, providing the ordered pairs {yₘ, y*ₘ}. The Least Squares solution for “a” and “b” requires only a 2×2 matrix inversion. For embodiments where both “a” and “b” are found via Least Squares fitting, it is not necessary to perform the adjustment (described above) for setting the ADC output to zero mean prior to solving for “a” and/or “b.” In general, the Least Squares solution for “a” and “b” will not provide a zero mean ADC output. In one embodiment, a Least Squares solution for “a” and “b” is found and applied, and another offset adjustment is then calculated and introduced (following a procedure similar to the zeroing described above) to provide a zero mean ADC output. In other embodiments, the gain term “a” is not included in the Least Squares calculation (e.g., assumed to be unity), which reduces the complexity of the solution. For embodiments where the Sₘ values are first adjusted to create a zero mean ADC output but where the gain adjustment is desired, the offset term “b” may be not included in the Least Squares solution, maintaining the zero mean ADC output while finding (and subsequently applying) the gain term “a”. In general, this will provide a fitting which is not as optimal as determined when “b” is allowed to introduce a non-zero mean into the output again. In one embodiment, the ADC output is adjusted by offset “k” to provide a zero mean, then a Least Squares solution of “a” and “b” is determined, and finally a new offset “k” is calculated and introduced to provide the zero mean ADC output. This embodiment may be motivated by considerations of numerical processing in the computations.

A Weighted Least Squares solution for “a” and “b” may be incorporated for each of the embodiments described above. In some embodiments, the weighting of the “fit” for each yₘ varies in accordance with the relative frequency of occurrence of each yₘ in the formation of the histograms. The variation of the weighting may be strictly in accordance to the histogram counts, or may be in accordance to the square root of the histogram counts (a tradeoff between weighting according to histogram counts and uniform weighting), or a higher root, or other. Weighted Least Squares fitting may also be in accordance to the absolute value of each yₘ, so that higher values of yₘ may be weighted more or less heavily compared to smaller absolute values of yₘ. Weighted Least Squares fitting may be a combination of in accordance to histogram and absolute value of yₘ, such that a product of the two weightings is formed and used as the weighting for each yₘ. As an example, the combination allows for fitting with a tapered de-emphasis of large absolute values of yₘ due to an input distribution which exercises the extreme values very rarely, but also allows for additional increasing influence of the lower absolute values yₘ, since the same error amount on a small absolute value of yₘ corresponds to a much larger relative error than the same error amount at a large absolute value of yₘ.

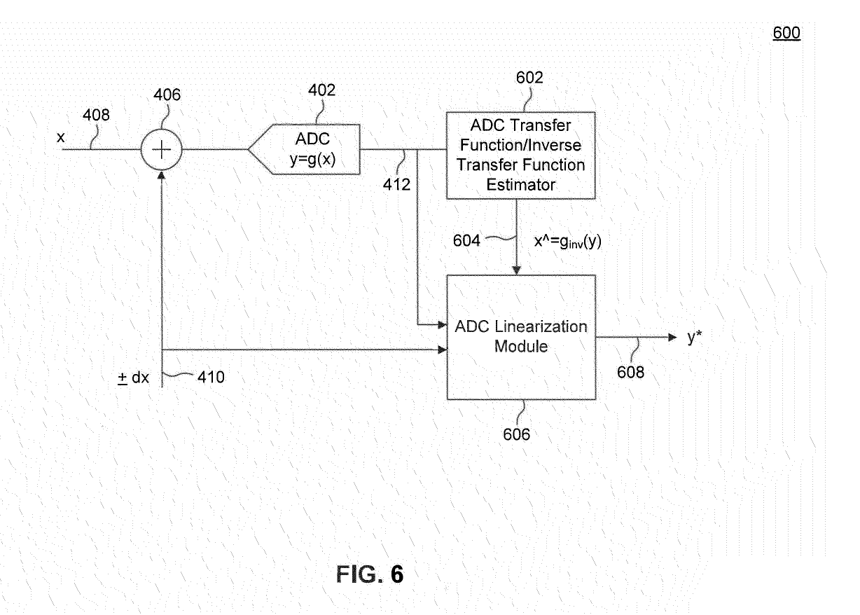

The set of y*ₘ values represents adjusted values of the ADC output, which are compensated for the non-linearity in the ADC transfer function y=g(x), but which maintain the units of the ADC output. In an embodiment, as further described in FIG. 6 below, the pairs {yₘ, y*ₘ} are stored (e.g., in a look up table) so that output values yₘ from an ADC are replaced respectively with corresponding adjusted output values y*ₘ, effectively linearizing the ADC output.

In another embodiment, the terms corresponding to evaluation at yₘ with m=1 and m=N are included in the preceding computations, with the numerator and denominator terms extended to the minimum and maximum digital code values as described above. In another embodiment, the values for y*ₘ, for m=1 and m=N, are extrapolated from the pairs (yₘ, y*ₘ}, m=2,3, . . . N−1, by fitting a first polynomial to the pairs for m=2, 3, . . . J_{low}, with J_{low}<N, and extrapolating to m=1, and by fitting a second polynomial to the pairs for m=J_{high}, J_{high}+1, . . . N−1 and extrapolating to m=N. The polynomial fittings may be simple extensions of straight lines formed by the m=2 and m=3 ordered pairs (for finding y*₁), and by the m=N−2 and m=N−1 ordered pairs (for finding y*_{N}), as an example.

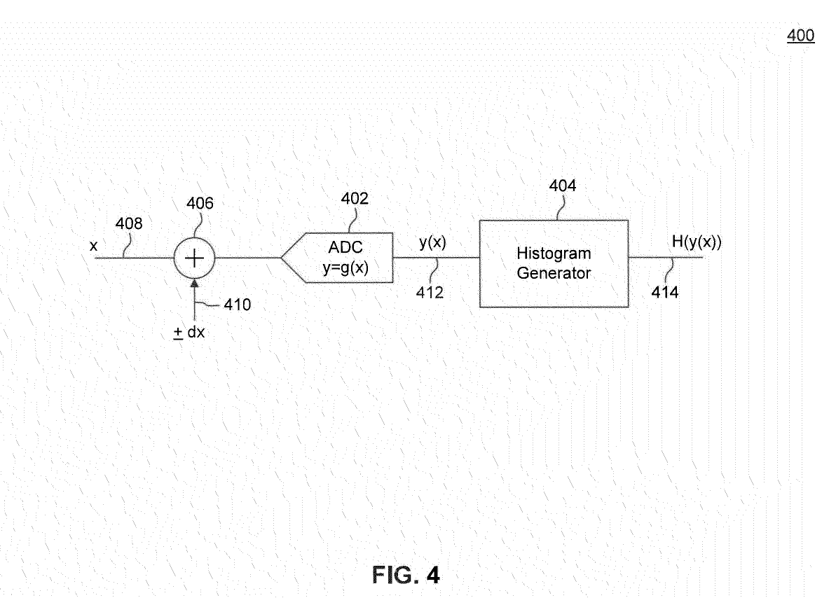

FIG. 4 illustrates an example system 400 for generating ADC output histograms according to an embodiment of the present invention. Example system 400 can be used in conjunction with example system 300 to enable embodiments of the present invention. More particularly, example system 400 may be used to generate input signals 312 and 314 of example system 300.

As shown in FIG. 4, example system 400 includes an ADC 402, a histogram generator module 404, and an adder circuit 406. Example system 400 receives an input signal 408. Input signal “x” 408 can be any signal as long as it spans the entire input dynamic range of ADC 402, so as to fully exercise ADC 402.

Adder circuit 406 is operable to add a calibration signal 410 to input signal 408. Adder circuit 406 may be any circuit capable of adding analog signals. In an embodiment, calibration signal 410 is a DC signal that takes either of two values “+dx” and “−dx.” The actual absolute value of “+dx” and “−dx” is not significant. In embodiments, calibration signal 410 takes the value “+dx” for the time needed for input signal 408 to sweep the entire input dynamic range of ADC 402, and then changes to “−dx” for an equal amount of time. Accordingly, calibration signal 410 allows example system 400 to produce two output histograms, H(y(x−dx)) and H(y(x+dx)). Alternatively, calibration signal 410 takes either of the values “0” and “+dx.” As a result, the produced output histograms are H(y(x−dx)) and H(y(x)).

The output of adder circuit 406 is applied to ADC 402 to generate ADC digital code output 412. Based on ADC digital code output 412, histogram generator 404 generates an ADC output histogram 414. Histogram generator 404 may generate cumulative or non-cumulative histograms of ADC output 412.

FIG. 6 illustrates an example system 600 for providing a linearized ADC according to an embodiment of the present invention. As shown in FIG. 6, example system 600 includes ADC 402, adder 406, a first module 602, and a second module 606.

As described above with reference to FIG. 4, adder circuit 406 is operable to add calibration signal 410 to input signal 408. The output of adder circuit 406 is applied to ADC 402 to generate ADC digital code output “y” 412.

Module 602 receives digital code output “y” 412 and generates an output signal 604. In an embodiment, signal 604 includes an estimate or approximation x̂ of gᵢₙᵥ(y), the inverse of the ADC transfer function. In another embodiment, signal 604 contains an estimate of the ADC transfer function. In a further embodiment, signal 604 includes mathematical representations of various linear segments of the ADC transfer function or of the inverse function (each linear segment representation being applicable for a respective input interval). In an embodiment, the mathematical representations provide a piecewise linear representation of the non-linear ADC transfer function or the inverse function gᵢₙᵥ(y). In another embodiment, signal 604 includes a mapping of digital code output values “yₘ” to adjusted digital code output values “y*ₘ.” The adjusted digital code output values y*ₘ can be generated by module 602 using any of the embodiments described above.

In an embodiment, module 602 accumulates a plurality of digital code outputs y 412 in order to generate output signal 604. In an embodiment, module 602 includes one or more other modules, including, for example, histogram generator 404, first differentiator module 302, second differentiator module 304, divider module 306, and integrator module 308. Module 604 implements one or more embodiments described above to calculate the estimate x̂ of gᵢₙᵥ(y), the ADC transfer function, and/or the above described mathematical representations of the ADC transfer function or the inverse function.

Module 602 provides output signal 604 to module 606. In embodiments, module 602 may periodically update, augment, or refine the estimate x̂ of gᵢₙᵥ(y) (or the ADC transfer function, or the mathematical representations) and provide the updated, augmented, or refined estimate (ADC transfer function or mathematical representations) via output signal 604 to module 606.

In addition to receiving output 604 from module 602, module 606 also receives digital code output “y” 412 of ADC 402 and calibration signal 410. Using signals 604, 412, and 410, module 606 outputs an adjusted digital code output “y*” 608 that corresponds to digital code output “y” 412.

In an embodiment, module 604 is operable to receive a continuous valued digital code output signal 412 (i.e., non-quantized). In this embodiment, module 604 may use the mathematical representations of the inverse function gᵢₙᵥ(y) provided from module 602 to calculate adjusted digital code output y* 608. For example, based on a received digital code output value “y” 412, module 606 identifies a respective linear segment of the inverse function (that corresponds to the input interval containing the value y 412) and uses the mathematical representation of that segment to generate a corresponding adjusted digital code output y* 608.

In another embodiment, module 604 is operable to receive a discrete valued digital code output signal 412 (i.e., quantized). In this embodiment, module 604 may rely on the mapping of digital code output values yₘ to adjusted digital code output values y*ₘ, provided by module 602, in order to calculate y* 608. In an embodiment, the mapping is stored in a look up table inside module 606, and thus module 606 simply performs a translation from yₘ to y*ₘ.

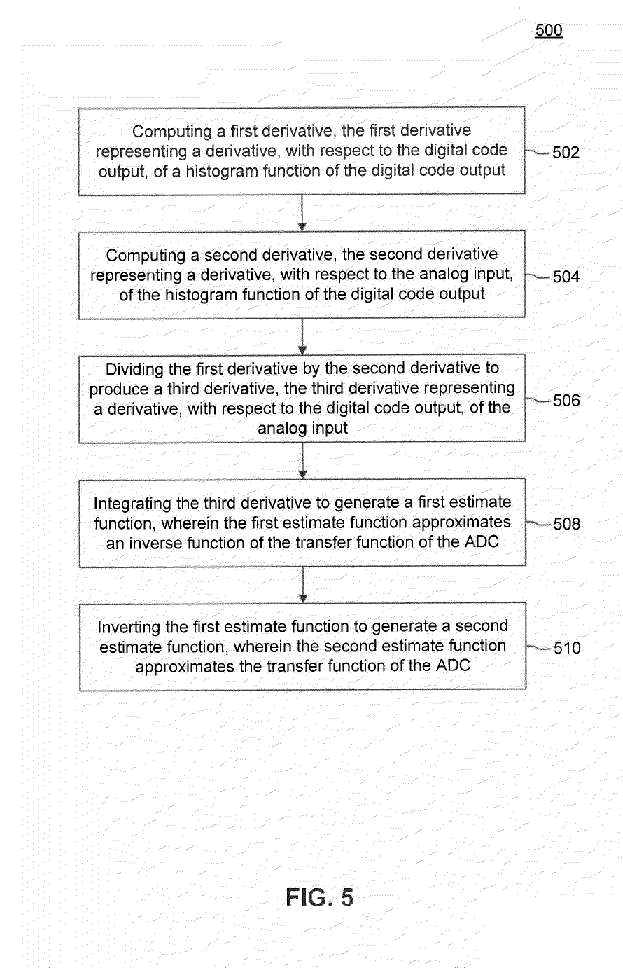

FIG. 5 is a process flowchart 500 of a method of estimating a transfer function of an ADC according to an embodiment of the present invention. The ADC receives an analog input and produces a digital code output according to the transfer function.

As shown in FIG. 5, process 500 begins in step 502, which includes computing a first derivative, the first derivative representing a derivative, with respect to the digital code output, of a histogram function of the digital code output. In an embodiment, computing the first derivative includes applying an input signal to the ADC, the input signal including voltage values that span a dynamic range of the ADC, to produce an output signal; generating an output histogram based on the output signal; and computing the first derivative based on the output histogram.

In an embodiment, step 502 includes computing a first local derivative, with respect to the digital code output, of the histogram function at a code bin of the output histogram. To fully characterize the transfer function of the ADC, a plurality of first local derivatives, corresponding to every code bin of the output histogram, may be computed. In an embodiment, the first local derivative is computed by determining a difference between respective counts of first and second code bins of the output histogram, the first code bin positively offset by a bin offset from the code bin and the second code bin negatively offset by the bin offset from the code bin; and dividing the difference by twice the bin offset value. The count of a code bin represents in a non-cumulative histogram the number of times that a value of the input signal is mapped to the digital code output, represented by the code bin. In a cumulative histogram, the count represents the number of times that a value of the input signal is mapped to a digital code output below and up to (and including) the digital code output, represented by the code bin.

Step 504 includes computing a second derivative, the second derivative representing a derivative, with respect to the analog input, of the histogram function of the digital code output. In an embodiment, computing the second derivative includes applying a first input signal to the ADC, the first input signal generated by adding a positive DC offset to the input signal, to produce a first output histogram; applying a second input signal to the ADC, the second input signal generated by adding a negative DC offset, of equal value but opposite polarity as the positive DC offset, to the input signal, to produce a second output histogram; and computing the second derivative based on the first and second output histograms.

In an embodiment, step 504 further includes computing a second local derivative, with respect to the analog input, of the histogram function at the code bin (i.e., same code bin used to compute the first local derivative). To fully characterize the transfer function of the ADC, a plurality of second local derivatives, corresponding to every code bin of the output histogram, may be computed. In an embodiment, the second local derivative is computed by determining a difference between the first and second output histograms for the code bin; and dividing the difference by twice the DC offset value to produce the second local derivative.

Subsequently, step 506 includes dividing the first derivative by the second derivative to produce a third derivative, the third derivative representing a derivative, with respect to the digital code output, of the analog input. In an embodiment, step 506 includes dividing the first local derivative by the second local derivative to produce a third local derivative, the third local derivative representing a local slope of the inverse function of the transfer function at a digital code output value that corresponds to the code bin.

Step 508 includes integrating the third derivative to generate a first estimate function, wherein the first estimate function approximates an inverse function of the transfer function of the ADC. In an embodiment, step 508 includes integrating the third local derivative to generate the first estimate function, wherein the estimate function linearly approximates the inverse function of the transfer function over a respective local interval of the digital code output.

Finally, step 510 includes inverting the first estimate function to generate a second estimate function, wherein the second estimate function approximates the transfer function of the ADC. In an embodiment, the second estimate function linearly approximates the transfer function of the ADC over a respective local interval of the analog input.

According to other embodiments, step 510 may be optional. The first estimate function is used to generate a mapping of ADC digital code output values to adjusted ADC digital code output values. The mapping may be stored in a look up table, which is used in real-time to linearize the ADC output.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

What is claimed is:

1. A method for estimating a transfer function of an analog-to-digital converter (ADC), wherein the ADC receives an analog input and produces a digital code output according to the transfer function, the method comprising:
computing a first derivative, the first derivative representing a derivative, with respect to the digital code output, of a histogram function of the digital code output;
computing a second derivative, the second derivative representing a derivative, with respect to the analog input, of the histogram function of the digital code output;
dividing the first derivative by the second derivative to produce a third derivative, the third derivative representing a derivative, with respect to the digital code output, of the analog input; and
integrating the third derivative to generate a first estimate function, wherein the first estimate function approximates an inverse function of the transfer function of the ADC.

2. The method of claim 1, wherein computing the first derivative comprises:
applying an input signal to the ADC, the input signal including voltage values that span a dynamic range of the ADC, to produce an output signal;
generating an output histogram based on the output signal; and
computing the first derivative based on the output histogram.

3. The method of claim 2, wherein computing the first derivative comprises:
computing a first local derivative, with respect to the digital code output, of the histogram function at a code bin of the output histogram.

4. The method of claim 3, further comprising:
determining a difference between respective counts of first and second code bins of the output histogram, the first code bin positively offset by a bin offset from the code bin and the second code bin negatively offset by the bin offset from the code bin; and
dividing the difference by twice the bin offset to produce the first local derivative.

5. The method of claim 3, wherein computing the second derivative comprises:
applying a first input signal to the ADC, the first input signal generated by adding a positive DC offset to the input signal, to produce a first output histogram;
applying a second input signal to the ADC, the second input signal generated by adding a negative DC offset, of equal value but opposite polarity as the positive DC offset, to the input signal, to produce a second output histogram;
computing the second derivative based on the first and second output histograms.

6. The method of claim 5, wherein computing the second derivative comprises:
computing a second local derivative, with respect to the analog input, of the histogram function at the code bin.

7. The method of claim 6, further comprising:
determining a difference between the first and second output histograms for the code bin; and
dividing the difference by twice the DC offset to produce the second local derivative.

8. The method of claim 6, further comprising:
dividing the first local derivative by the second local derivative to produce a third local derivative, the third local derivative representing a local slope of the inverse function of the transfer function at a digital code output value that corresponds to the code bin.

9. The method of claim 8, further comprising:
integrating the third local derivative to generate the first estimate function, wherein the first estimate function linearly approximates the inverse function of the transfer function over a respective local interval of the digital code output.

10. The method of claim 1, further comprising:
inverting the first estimate function to generate a second estimate function, wherein the second estimate function approximates the transfer function of the ADC.

11. The method of claim 10, wherein the second estimate function linearly approximates the transfer function of the ADC over a respective local interval of the analog input.

12. The method of claim 1, wherein the histogram function is cumulative or non-cumulative.

13. A system for estimating a transfer function of an analog-to-digital converter (ADC), wherein the ADC receives an analog input and produces a digital code output according to the transfer function, the system comprising:
a first differentiator module configured to compute a first derivative, the first derivative representing, a derivative, with respect to the digital code output, of a histogram function of the digital code output;
a second differentiator module configured to compute a second derivative, the second derivative representing a derivative, with respect to the analog input, of the histogram function of the digital code output;
a divider module configure to divide the first derivative by the second derivative to produce a third derivative, the third derivative representing a derivative, with respect to the digital code output, of the analog input; and
an integrator module configured to integrate the third derivate to generate a first estimate function, wherein the first estimate function approximates an inverse function of the transfer function of the ADC.

14. The system of claim 13, further comprising:
a histogram generator module configured to generate an output histogram based on an output signal of the ADC, the output signal produced by applying an input signal to the ADC, the input signal including voltage values that span a dynamic range of the ADC, to produce an output signal.

15. The system of claim 14, wherein the first differential module is configured to compute the first derivative based on the output histogram.

16. The system of claim 15, wherein the first differentiator module is further configured to compute a first local derivative, with respect to the digital code output, of the histogram function at a code bin of the output histogram.

17. The system of claim 16, wherein the first differentiator module is further configured to determine a difference between respective counts of first and second code bins of the output histogram, the first code bin positively offset by a bin offset from the code bin and the second code bin negatively offset by the bin offset from the code bin;
and to divide the difference by twice the bin offset to produce the first local derivative.

18. The system of claim 16, wherein the histogram generator module is further configured to generate a first output histogram and a second output histogram, the first output histogram generated based on a first input signal applied to the ADC, the first input signal being offset by a positive DC offset relative to the input signal, and the second output histogram generated based on a second input signal applied to the ADC, the second input signal being offset by a negative DC offset relative to the input signal.

19. The system of claim 18, wherein the second differentiator module is configured to compute the second derivative based on the first and second output histograms.

20. The system of claim 18, wherein the second differentiator module is further configured to compute a second local derivative, with respect to the analog input, of the histogram function at the code bin.

21. The system of claim 20, wherein the second differentiator module is further configured to determine a difference between the first and second output histograms for the code bin; and divide the difference by twice the DC offset to produce the second local derivative.

22. The system of claim 21, wherein the divider module is further configured to divide the first local derivative by the second local derivative to produce a third local derivative, the third local derivative representing a local slope of the inverse function of the transfer function at a digital code output value that corresponds to the code bin.

23. The system of claim 22, wherein the integrator module is configured to integrate the third local derivative to generate the first estimate function, wherein the first estimate function linearly approximates the inverse function of the transfer function over a respective local interval of the digital code output.

24. The system of claim 13, further comprising:
an inverter module configured to invert the first estimate function to generate a second estimate function, wherein the second estimate function approximates the transfer function of the ADC.

25. The system of claim 24, wherein the second estimate function linearly approximates the transfer function of the ADC over a respective local interval of the analog input.
